(19) United States
(12) Patent Application Publication
(10) Pub. No.: US 2002/0007286 A1
(43) Pub. Date: Jan. 17, 2002

(54) Health care system, server computer system and machine-readable data storage medium

(75) Inventor: Katsuro Okamoto, Tokyo (JP)

Correspondence Address: SUGHRUE, MION, ZINN, MACPEAK & SEAS, 2100 Pennsylvania Avenue, N.W., Washington, DC, 20037, US

(73) Assignee: NEC CORPORATION

(21) Appl. No.: 09/900,891

(22) Filed: Jul. 10, 2001

(30) Foreign Application Priority Data
Jul. 14, 2000 (JP) 214863/2000

(51) Int. Cl. G06F 17/60; G06F 7/00; G06F 17/00

(52) U.S. Cl. 705/2; 707/104.1

(57) ABSTRACT

A customer registers vital signs and answers to medical examination by an interview respectively from a home health care terminal in a vital information database. A medical institution and a health service supplier prepare a comment, referring to the vital information database via a health care data reference viewer, register it in an information provision database and also register ready-made contents in a health related information database in case the ready-made contents are utilized for advice information. The customer refers to a comment and advice in the information provision database via the home health care terminal. A specific individual refers a health condition of his/her parents and others who remotely live via a specific individual terminal. A provider calculates storage expenses using a health care database server and charges the medical institution and the health service supplier the expenses.

### BACKGROUND OF THE INVENTION

1. Field of the Invention

The present invention relates to a health care system, a health care method and a machine-readable data storage medium on which a program for health care is recorded, particularly relates to a health care system and a health care method for managing an everyday health condition, guiding the improvement and grasping the effect to improve daily living habit in a home and a machine-readable data storage medium on which a program for health care is recorded.

2. Description of the Related Prior Art

As patients of a disease due to living habit increase, everyday living habit in a home is required to be improved. Therefore, a medical institution and a health service supplier utilize a home health care system that manages an everyday health condition, guides the improvement and grasps the effect.

Heretofore, a medical institution and a health service supplier use a home health care system in which a database server for health care is installed, a home health care terminal is installed in a home of an outpatient of the medical institution and a home of a party to a contract and these are connected via a telecommunication line. This terminal collects everyday health information and everyday vital information of the outpatient and the party to the contract and sends them to the database server via the telecommunication line. The medical institution and the health service supplier analyze the information using the database server and advise utilizing a telephone and a simple comment sending function if necessary.

As described above, the health care system is a system that a medical institution and a health service supplier individually install a database server and directly communicate with the database server via a common carrier leased line to connect to a viewer for reference.

When the above-mentioned health care system is used, a medical institution and a health service supplier are required to install a database server, a terminal and a telecommunication line at their own expenses. Therefore, there is a problem that considerable investment in facilities is required independent of the number of objects.

There is also a problem that as line expenses, dedicated software and others are required for an outpatient and a party to a contract to access to the database server, it costs very much investment and operation expenses.

### SUMMARY OF THE INVENTION

The object of the invention is to provide a health care system and a health care method wherein much initial plant and equipment investment is not required for a medical institution and a health service supplier and a load upon system operation and maintenance personnel is reduced and a machine-readable data storage medium on which a program for health care is recorded.

Another object of the invention is to provide a health care system and a health care method wherein the reduction of operation costs such as a charge for communication and the selection of a medical specialist and a health service supplier of good quality are enabled for an individual to whom health care service is provided and a machine-readable data storage medium on which a program for health care is recorded.

To achieve the objects, the health care system is a health care system that manages a health condition, guides the improvement and grasps the effect, is provided with a computer system having a database, plural viewers for referring to the contents of the database, a terminal and a channel mutually connecting the computer system, the viewers and the terminal, the computer system includes means for registering individual information and vital information respectively sent from the terminal in the database, means for registering a comment sent from the viewer in the database and means for calculating database management expenses and charging the expenses, the viewer includes means for referring to the database and means for sending the comment related to the vital information to the computer system, and the terminal includes means for sending the vital information to the computer system and means for referring to the database.

Another health care system is a health care system that manages a health condition, guides the improvement and grasps the effect, is provided with a health care database server used by a provider, plural health care data reference viewers used for a health care institution, a home health care terminal used by a customer of the health care institution and the Internet mutually connecting the health care database server, the health care data reference viewers and the home health care terminal, the health care database server is provided with a vital information database and an information provision database, the health care database server includes means for accepting an order for database management business from the health care institution and registering the individual data of the customer, means for registering vital information sent from the home health care terminal in the vital information database, means for registering a comment sent from the health care data reference viewer in the information provision database and means for calculating database management expenses and charging the health care institution the expenses, the health care data reference viewer includes means for referring to the vital information database and means for sending a comment related to vital information of the customer in the vital information database to the health care database server, and the home health care terminal includes means for sending the vital information of the customer to the health care database server and means for referring to the information provision database.

A health care method according to the invention includes a step that the health care database server accepts an order for database management business from a medical institution or a health service supplier and registers the individual data of a customer of the medical institution or the health service supplier, a step for sending the vital information of the customer from the home health care terminal to the health care database server via the Internet, a step for registering the sent vital information in the vital information database of the health care database server, a step that the health care data reference viewer of the medical institution or the health service supplier refers to the vital information database via the Internet, a step for sending a comment related to the vital information of the customer from the health care data reference viewer to the health care database server via the Internet, a step for registering the sent comment in the information provision database of the health care database server, a step that the home health care terminal refers to the information provision database via the Internet and a step that the health care database server calculates database management expenses and charges the medical institution or the health service supplier the expenses.

A machine-readable data storage medium according to the invention records a program for instructing the server to execute processing for accepting an order for database management business from a medical institution or a health service supplier and registering the individual data of a customer of the medical institution or the health service supplier, processing for registering vital information sent from a home health care terminal used by the customer via the Internet in a vital information database, processing for registering a comment sent from a health care data reference viewer used by the medical institution or the health service supplier via the Internet in an information provision database and processing for calculating database management expenses and charging the medical institution or the health service supplier the expenses.

### BRIEF DESCRIPTION OF THE DRAWINGS

The above and other objects, features and advantages of the present invention will become apparent from the following detailed description when taken with the accompanying drawings in which:

FIG. 1 is a block diagram showing a first concrete example of a health care system;

FIG. 2 is a flowchart showing a concrete example of a health care method; and

FIG. 3 is a block diagram showing a second concrete example of the health care system.

### DETAILED DESCRIPTION OF THE PREFERRED EMBODIMENTS

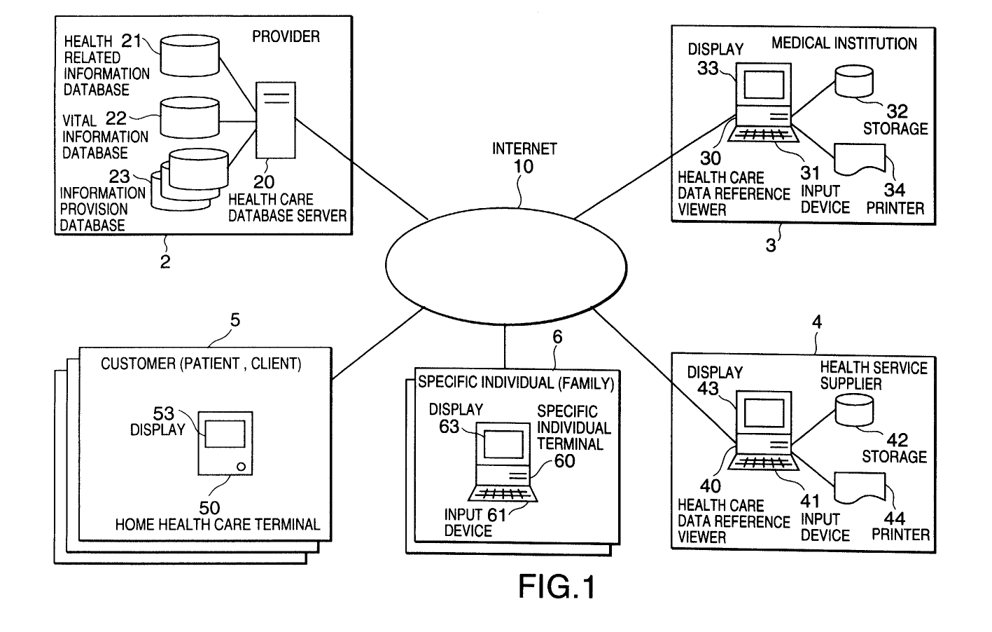

FIG. 1 is a block diagram showing the configuration of a health care system equivalent to a first embodiment of the invention. The health care system equivalent to the first embodiment is composed of a health care database server 20, a health care data reference viewer 30, a health care data reference viewer 40, a home health care terminal 50, a specific individual terminal 60 and the Internet 10 mutually connecting these.

The health care database server 20 is information processing equipment used by a provider 2 which is an application service provider (ASP). The health care database server is provided with a health related information database 21, a vital information database 22 and an information provision database 23 inside or outside. The health care database server 20 is provided with a function for accepting an order for a database management business, registering the personal data of a customer and setting access authority to a database and a function for calculating data storage expenses and charging the expenses.

The health care data reference viewer 30 means a personal computer used by the medical institution 3. This is provided with an input device 31 such as a keyboard, a storage 32 for temporarily storing data and an output device such as a display 33 and a printer 34.

The medical institution 3 is provided with access authority to a vital information database 22 related to its own patient and can refer to vital information data related to the patient using the health care data reference viewer 30. The medical institution also requests the health care database server 20 to register diagnosis and advice based upon the data and information related to health prepared in the health related information database 21 beforehand in the information provision database 23 every patient using the health care data reference viewer 30.

The health care data reference viewer 40 means a personal computer used by a health service supplier 4. The health care data reference viewer 40 is provided with an input device 41 such as a keyboard, a storage 42 for temporarily storing data and an output device such as a display 43 and a printer 44. The medical institution 3 is given access authority to the vital information database 22 related to its own client and can refer to vital information data using the health care data reference viewer 40. The medical institution 3 also requests the health care database server 20 to register diagnosis and advice based upon the vital information data and health related information prepared in the health related information database 21 as contents in the information provision database 23 every client using the health care data reference viewer 40.

The home health care terminal 50 means a dedicated terminal used by a customer 5, that is, a patient of the medical institution 3 or a client of the health service supplier 4 and is provided with a display 53 so that the result of the measurement of blood pressure, an electrocardiogram, answers to a medical examination by an interview and others can be input. The display 53 may be also provided with a touch panel for screen display and data input. The home health care terminal 50 is provided with a function for requesting everyday vital signs of a patient or a client and answers to a medical examination by an interview to be registered in the vital information database 22 of the provider 2 and a function for referring to the information provision database 23. The home health care terminal 50 is not limited to a dedicated terminal and may be also a general purpose personal computer if only it has a function for inputting the data of a sphygmomanometer and an electrocardiograph.

The specific individual terminal 60 means a personal computer used by a specific individual 6. The specific individual terminal is provided with an input device 61 such as a keyboard and a display 63. The specific individual 6 means an individual required to check a patient's or a client's health condition. It is normally a close relative such as a family. The specific individual terminal 60 is provided with access authority to the information provision database 23. The specific individual 6 can refer to the health condition of a close relative and others who remotely lives using the specific individual terminal 60.

As described above, the provider 2 is entrusted with the management of databases by the medical institution 3 or the health service supplier 4 as out sourcing business. Hereby, the provider executes accounting for the management of the vital information of a patient or a client provided everyday, the management of the information provision database 23 and the use of contents such as health guidance information and gets continual income.

The medical institution 3 or the health service supplier 4 to which or to whom access authority to the vital information database 22 is offered refers to the vital information data of its own patient or client and registers diagnosis and advice based upon the data and information related to health beforehand prepared in the provider 2 in the information provision database 23 every patient or client. The specific individual 6 receives suitable advice via the home health care terminal 50, referring to the information provision database 23.

FIG. 1 shows both the medical institution 3 and the health service supplier 4, however, only either may be also included.

The provider 2 may be also an internet service provider (ISP). In this case, ISP provides the database server in this embodiment and performs the above-mentioned health care business. ISP can get not only the income of the connection charge of the Internet but the income of health care business.

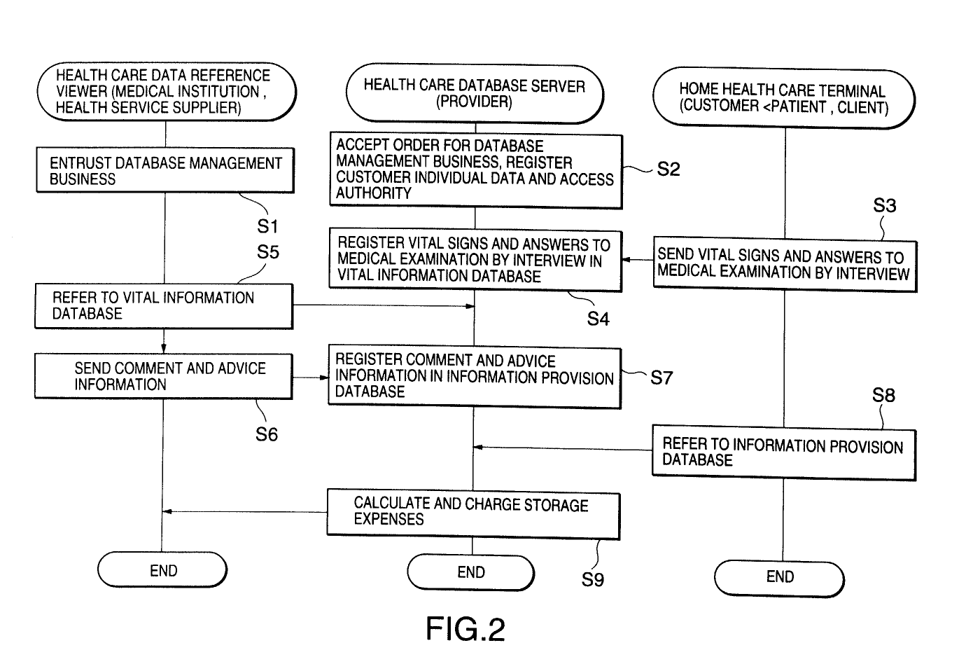

Next, referring to FIGS. 1 and 2, the operation will be described. FIG. 2 is a flowchart showing the operation of the first embodiment.

First, the medical institution 3 and the health service supplier 4 entrust the outside provider 2 with the management business of the databases related to daily vital information such as vital data and answers to a medical examination by an interview collected from an outpatient and a client under contract (a step S1). The provider 2 accepts the management business, registers the individual data of the customer 5 in the health care database server 20 and sets access authority to the databases (a step S2). The individual data of the customer 5 means the name, the user identification data (ID), the password and others of the customer 5, that is, a patient or a client. Further, the medical institution 3 and the health service supplier 4 also registers the individual data of the specific individual 5 if necessary.

The home health care terminal 50 installed in each home of the customer 5 sends vital signs measured everyday by the customer and answers to a medical examination by an interview to the health care database server 20 of the provider 2 via the Internet 10 everyday (a step S3).

The health care database server 20 registers these signs and answers in the vital information database 22 (a step S4).

The medical institution 3 and the health service supplier 4 refer to the vital information database 22 via the health care data reference viewer 30 or 40 (a step S5). The medical institution 3 and the health service supplier 4 prepare comment including suitable diagnosis, daily life guidance and health guidance respectively related to an object based upon the referred data and sends it to the health care database server 20 (a step S6). The health care database server 20 registers the comment in the information provision database 23 (a step S7).

In case information prepared in the health related information database 21 beforehand as the ready-made guidance and prescription of meals, exercise, rehabilitation and others is utilized, the medical institution 3 and the health service supplier 4 request the information to be also registered in the information provision database 23. The medical institution 3 and the health service supplier 4 utilize these information as advice for an individual. They perform setting according to the health condition of the customer 5 such as change the items of medical examination by an interview and the items of measurement if necessary via the health care data reference viewer 30 or 40.

The customer 5 refers to the information provision database 23 via the home health care terminal 50 when he/she views the comment and the advice of the medical institution 3 and the health service supplier 4 and instructs them to be displayed on the display 53 (a step S8). The information provision database 23 is a database every customer 5 and the access authority is set individually in units of the customer 5. The customer 5 can see only the information of his/her database.

The specific individual 6 can always refer to the health condition of his/her parents and others who remotely live utilizing the specific individual terminal 60.

The health care database server 20 calculates expenses for storage every fixed period and sends a bill for storage expenses to the health care data reference viewers 30 and 40 (a step S7). The medical institution 3 and the health service supplier 4 pay the expenses to the provider via a financial institution and others. The storage expenses include a charge for storage in the database, a charge for the utilization of contents for provision and a charge for access to the database. These expenses are calculated according to a predetermined system such as a system that a charge per patient or client is fixed and a system that a charge is proportional to the frequency of access to the database.

The health care database server 20 further prepares a monthly report including the health information, the summary and the opinion of the customer 5. The monthly report is sent to the customer 5 by mail or by facsimile. Or it is sent to the home health care terminal 50 and may be also printed by a printer via the home health care terminal 50.

Next, a second embodiment of the invention will be described.

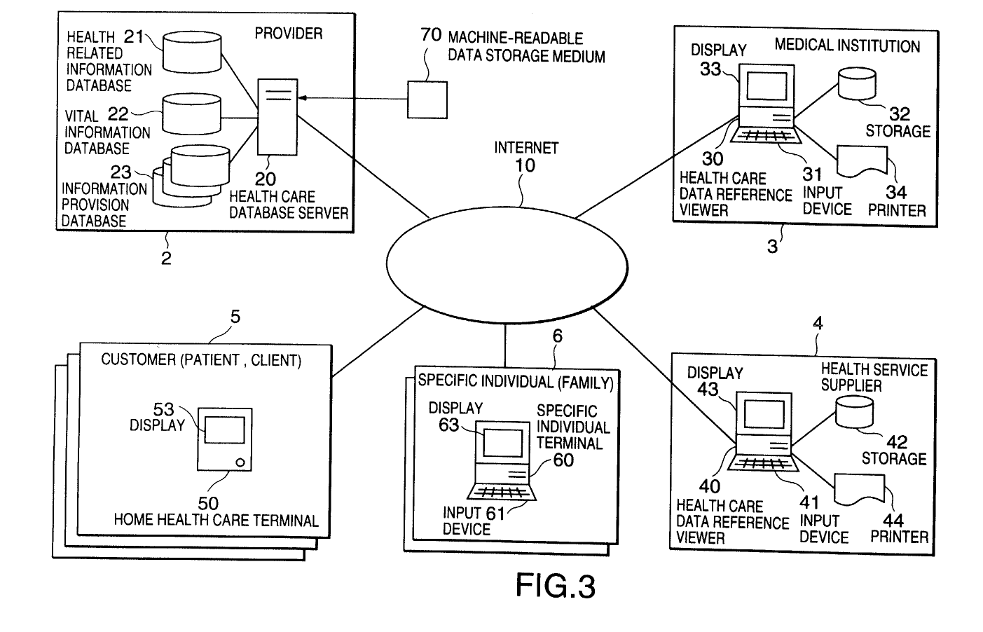

FIG. 3 is a whole block diagram showing the second embodiment. As shown in FIG. 3, the second embodiment includes a machine-readable data storage medium 70 in addition to the configuration of the first embodiment shown in FIG. 1. The machine-readable data storage medium 70 records a program for health care. The machine-readable data storage medium 70 may be a magnetic disk, a semiconductor memory, an optical disk and other record media.

The program for health care is read from the machine-readable data storage medium 70 by the health care database server 20. The health care database server 20 executes processing according to the program for health care.

The health care database server 20 is entrusted with database management business by the medical institution 3 or the health service supplier 4 under the control of the program for health care and executes processing for registering the individual data of the customer 5 of the medical institution 3 or the health service supplier 4. Next, the health care database server executes processing for registering vital information sent from the home health care terminal 50 used by the customer 5 via the Internet 10 in the vital information database 22. Third, the health care database server executes processing for registering a comment sent from the health care data reference viewer 30 or 40 used by the medical institution 3 or the health service supplier 4 via the Internet 10 in the information provision database 23. Finally, the health care database server executes processing for calculating database management expenses and charging the medical institution 3 or the health service supplier 4 the expenses.

Further, the health care database server 20 executes processing for registering information provided to the customer as advice information via the health care data reference viewer 30 or 40 out of information in the health related information database 21 in the information provision database 23 under the control of the program for health care.

Further, the health care database server 20 executes processing for individually setting access authority to the information provision database 23 as a database every customer 5 under the control of the program for health care.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed is:

1. A health care system that manages a health condition, guides the improvement and grasps the effect, comprising:
a computer system provided with a database;
plural viewers for referring to the contents of the database;
a terminal; and
a channel mutually connecting the computer system, the viewers and the terminal, wherein:
the computer system includes means for registering individual information and vital information respectively sent from the terminal in the database, means for registering a comment sent from the viewer in the database and means for calculating database management expenses and charging the expenses;
the viewer includes means for referring to the database and means for sending the comment related to the vital information to the computer system; and
the terminal includes means for sending the vital information to the computer system and means for referring to the database.

2. A health care system that manages a health condition, guides the improvement and grasps the effect, comprising:
a health care database server used by a provider;
plural health care data reference viewers used by a health care institution;
a home health care terminal used by a customer of the health care institution; and
the Internet mutually connecting the health care database server, the health care data reference viewers and the home health care terminal, wherein:
the health care database server is provided with a vital information database and an information provision database;
the health care database server includes means for accepting an order for database management business from the health care institution and registering the individual data of the customer, means for registering vital information sent from the home health care terminal in the vital information database, means for registering a comment sent from the health care data reference viewer in the information provision database and means for calculating database management expenses and charging the health care institution the expenses;
the health care data reference viewer includes means for referring to the vital information database and means for sending a comment related to the vital information of the customer in the vital information database to the health care database server; and
the home health care terminal includes means for sending the vital information of the customer to the health care database server and means for referring to the information provision database.

3. The health care system according to claim 2, wherein:
the health care institution is a medical institution or a health service supplier or both the medical institution and the health service supplier.

4. The health care system according to claim 2, wherein:
the health care database server is provided with a health related information database; and
the health care data reference viewer includes means for requesting the health care database server to register information provided to the customer as advice information out of information in the health related information database in the information provision database.

5. The health care system according to claim 4, wherein:
the health care database server includes means for individually setting access authority to the information provision database as a database every customer.

6. The health care system according to claim 5, further comprising:
a specific individual terminal connected to the Internet, wherein:
the health care database server includes means for giving access authority to a database of a specific customer out of the information provision databases to the specific individual terminal; and
the specific individual terminal includes means for referring to the database to which the access authority is given.

7. A health care method for managing a health condition, guiding the improvement and grasping the effect, comprising:
a step that a health care database server accepts an order for database management business from a medical institution or a health service supplier and registers the individual data of a customer of the medical institution or the health service supplier;
a step for sending the vital information of the customer from a home health care terminal to the health care database server via the Internet;
a step for registering the sent vital information in a vital information database of the health care database server;
a step that a health care data reference viewer of the medical institution or the health service supplier refers to the vital information database via the Internet;
a step for sending a comment related to the vital information of the customer from the health care data reference viewer to the health care database server via the Internet;
a step for registering the sent comment in an information provision database of the health care database server;
a step that the home health care terminal refers to the information provision database via the Internet; and
a step that the health care database server calculates database management expenses and charges the medical institution or the health service supplier the expenses.

8. The health care method according to claim 7, further comprising:
a step for requesting the health care database server to register information provided to the customer as advice information by the health care data reference viewer out of information in a health related information database of the health care database server in the information provision database via the Internet.

9. The health care method according to claim 8, further comprising:
a step that the health care database server individually sets access authority to the information provision database as a database every customer.

10. The health care method according to claim 9, further comprising:
a step that the health care database server gives access authority to a database of a specific customer out of the information provision databases to a specific individual terminal; and
a step that the specific individual terminal refers to the database to which access authority is given.

11. A server computer system, comprising:
a health care data reference viewer via the Internet used by a medical institution or a health service supplier;
a home health care terminal via the Internet used by a customer of the medical institution or the health service supplier; and
a vital information database and an information provision database mutually connected, wherein:
the server computer system includes:
means for accepting an order for database management business from the medical institution or the health service supplier and registering the individual data of the customer;
means for registering vital information sent from the home health care terminal in the vital information database;
means for registering a comment sent from the health care data reference viewer in the information provision database; and
means for calculating database management expenses and charging the medical institution or the health service supplier the expenses.

12. The server computer system according to claim 11, further comprising:
a health related information database; and
means for registering information provided to the customer as advice information by the health care data reference viewer out of information in the health related information database in the information provision database.

13. The server computer system according to claim 12, comprising:
means for individually setting access authority to the information provision database as a database every customer.

14. The server computer system according to claim 13, further comprising:
means for giving access authority to a database of a specific customer out of the information provision databases to a specific individual terminal connected to the Internet.

15. A machine-readable data storage medium that records a program for instructing a computer system to execute:
processing for accepting an order for database management business from a medical institution or a health service supplier and registering the individual data of a customer of the medical institution or the health service supplier;
processing for registering vital information sent from a home health care terminal used by the customer via the Internet in a vital information database;
processing for registering a comment sent from a health care data reference viewer used by the medical institution or the health service supplier via the Internet in an information provision database; and
processing for calculating database management expenses and charging the medical institution or the health service supplier the expenses.

16. The machine-readable data storage medium according to claim 15, wherein:
a program for instructing a computer system to further execute processing for registering information provided to the customer as advice information by the health care data reference viewer out of information in a health related information database in the information provision database is recorded.

17. The machine-readable data storage medium according to claim 16, wherein:
a program for instructing a computer system to further execute processing for individually setting access authority to the information provision database as a database every customer is recorded.
